(19) United States
(12) Patent Application Publication
(10) Pub. No.: US 2026/0138656 A1
(43) Pub. Date: May 21, 2026

(54) LEVEL MONITORING AND AUTOMATIC LEVELING SYSTEM FOR RAIL TRANSPORTER

(71) Applicant: EAST CHINA JIAOTONG UNIVERSITY, NANCHANG, JIANGXI (CN)

(72) Inventors: JUN HU, NANCHANG (CN); XIAODONG MAO, NANCHANG (CN); MAOHUA XIAO, NANCHANG (CN); HAO CHEN, NANCHANG (CN); JIAWEN CHEN, NANCHANG (CN); JIANQUAN YAO, NANCHANG (CN)

(21) Appl. No.: 19/450,740

(22) Filed: Jan. 16, 2026

Related U.S. Application Data
(63) Continuation of application No. PCT/CN2024/132892, filed on Nov. 19, 2024.

(30) Foreign Application Priority Data
Nov. 27, 2023 (CN) 202311586652.3

(51) Int. Cl. B61L 99/00

(52) U.S. Cl. CPC B61L 99/002

(57) ABSTRACT

A level monitoring and automatic leveling system for a rail transporter, including: a transporter, two auxiliary rails, brackets, support columns, and a track. The brackets are fixed on the support columns, the track is arranged on the brackets; the two auxiliary rails are arranged on both ends of each bracket; the transporter is configured to run on the track, and a balance of the transporter is configured to be maintained through the two auxiliary rails. During transporting cargo, the transporter is configured to automatically detect a tilt angle. When the tilt angle deviates, the transporter automatically adjusts a horizontal position of a cargo container of the transporter, keeping the cargo container in a horizontal state to achieve automatic leveling. An operating speed of the transporter can be adjusted, enabling the transporter to run at a set speed; an electromagnetic braking device is arranged to achieve braking of the transporter.

### CROSS-REFERENCE TO RELATED APPLICATIONS

The present application is a continuation-application of International (PCT) Patent Application No. PCT/CN2024/132892, filed on Nov. 19, 2024, which claims priority to Chinese Patent Application No. 202311586652.3, filed on Nov. 27, 2023, the entire contents of which are incorporated herein by reference.

### TECHNICAL FIELD

The present disclosure relates to the technical field of rail transporters, and in particular, to a level monitoring and automatic leveling system for a rail transporter.

### BACKGROUND

Agricultural mountain rail transporters are specialized transportation facilities used in agricultural production, mainly for transporting agricultural products, agricultural machinery, agricultural supplies, as well as workers and farmers in areas such as mountainous farms, orchards, and farmland. Their functions mainly include the following aspects: 1. Improving agricultural production efficiency: Agricultural mountain rail transporters can quickly and safely transport agricultural products from picking points such as farmland or orchards to centralized processing or sales locations, avoiding inconvenient mountain roads and traffic congestion, thereby improving agricultural production efficiency. 2. Reducing the loss rate of agricultural products: During transportation, agricultural products are often susceptible to factors such as jolting and impact, leading to losses. Using agricultural mountain rail transporters may reduce vibration and impact during transportation, ensure the safety of transported goods, and lower the cargo damage rate during transport. 3. Improving farmers' labor efficiency: Agricultural mountain rail transporters can quickly and conveniently transport farmers, workers, agricultural machinery, and other supplies, significantly reducing the transportation burden on farmers, improving their labor efficiency, and reducing the rate of work-related injuries. 4. Environmental protection and energy saving: Compared to fuel-powered vehicles, agricultural mountain rail transporters use electricity as power, are more environmentally friendly, which may reduce exhaust pollution and energy consumption and help protect the environment.

In the related art, agricultural products and agricultural supplies are mainly transported manually, by vehicles, by monorail transporters, or by dual-rail transporters. Manual transportation is a traditional method commonly used in agricultural production, but it is inefficient, prone to labor shortages and high labor intensity. Furthermore, the amount of cargo and distance transported are limited, and it is highly susceptible to weather conditions. Vehicle transportation can quickly and conveniently transport large quantities of agricultural products or supplies, but in areas with complex terrain such as mountains, numerous problems exist, including narrow roads, steep slopes, slippery conditions, and a high accident risk. Additionally, vibrations and jolts during transportation can easily cause cargo breakage, leading to higher costs. Monorail transporters are devices that transport agricultural supplies and products via a rail. Installed at elevated positions for cargo handling, they are suitable for rugged terrain like mountainous areas. Dual-rail transporters are similar to monorail transporters but are designed with two parallel tracks, thereby significantly increasing transport capacity and suitability for long-distance transportation of large quantities of goods and supplies. However, current monorail and dual-rail transport cars have poor stability. For example, transport cars on monorails are prone to tipping when turning or when the load is unbalanced on both sides. Similarly, cargo inside dual-rail transport cars is highly susceptible to spilling during ascent and descent.

### SUMMARY OF THE DISCLOSURE

A level monitoring and automatic leveling system for a rail transporter, including: a transporter, two auxiliary rails, brackets, support columns, and a track;
wherein the brackets are fixed on the support columns, the track is arranged on the brackets; each of the brackets is a U-shaped bracket; the two auxiliary rails are arranged on both ends of each bracket; the transporter is configured to run on the track, and a balance of left and right ends of the transporter is configured to be maintained through the two auxiliary rails;
during a process of transporting cargo, the transporter is configured to automatically detect a tilt angle of the transporter; in a case where the tilt angle deviates, the transporter is configured to automatically adjust a horizontal position of a cargo container of the transporter, keeping the cargo container in a horizontal state to achieve automatic leveling; an operating speed of the transporter is configured to be adjusted by detecting the operating speed, for enabling the transporter to run at a set speed; an electromagnetic braking device is arranged to achieve braking of the transporter, preventing the cargo from falling and enabling emergency braking in unexpected situations;
wherein each bracket comprises a crossbar and two vertical rods; the track comprises a sliding groove and a rack; the crossbar is arranged on a corresponding support column; the two vertical rods are fixed on both ends of the crossbar; each vertical rod is configured to support a corresponding auxiliary rail; two self-stabilizers are arranged, each between the transporter and a corresponding auxiliary rail to prevent the transporter from swaying left and right; a middle of the track is recessed to define the sliding groove, and a right side of the track is arranged with the rack; the sliding groove is configured to provide guidance for movement of the transporter; the rack is configured to mesh with a gear of the transporter, providing a transmission foundation for the transporter and further serving a guiding role;
wherein each self-stabilizer comprises a hydraulic damper, a third iron caster wheel, a slider, and a length-adjustable motor; the two self-stabilizers are arranged on left and right sides of the cargo container respectively; a bottom of the length-adjustable motor is fixed to the chassis frame; a length-adjustable rod of the length-adjustable motor is connected to the slider; the third iron caster wheel is connected to the slider via the hydraulic damper; the hydraulic damper is configured to push the third iron caster wheel into the sliding groove of a corresponding auxiliary rail;
in a case where the cargo container shifts left or right due to uneven force, the hydraulic damper pushes the cargo container back to a balanced state;
in a case where the transporter is moving, the third iron caster wheel moves within the sliding groove of the corresponding auxiliary rail;
in a case where a front or a rear of the cargo container is lifted by the two hydraulic jacks, the controller controls the length-adjustable motor to pull the slider downward, keeping the third iron caster wheel at a same level as the corresponding auxiliary rail, preventing the self-stabilizer from being overstressed and broken due to tilt of the cargo container.

In some embodiments, the transporter includes a head, a fuel tank, a generator, a controller, a motor speed regulator, an electric motor, a speed sensor, a transmission device, a gearbox, a first iron caster wheel, a first inclination sensor, a hydraulic jack, an electromagnetic braking device, two second iron caster wheels, a chassis frame, a cargo container, a second inclination sensor, a first displacement sensor, and a second displacement sensor; the head and the cargo container are arranged on the chassis frame; the first iron caster wheel and the two second iron caster wheels are arranged below the chassis frame respectively; the fuel tank, the generator, the controller, the motor speed regulator, the electric motor, speed sensor, the gearbox, and the first inclination sensor are all arranged in the head; the fuel tank is configured to supply gasoline to the generator; the generator is configured to convert the gasoline into electrical energy to power the electric motor; the controller is electrically connected to the motor speed regulator; the motor speed regulator is electrically connected to the electric motor; the controller is configured to control an output of the motor speed regulator, for controlling a rotational speed of the electric motor; a rotating shaft of the electric motor is connected to the gearbox; an output end of the gearbox is connected to the transmission device; the electric motor is configured to drive the gearbox, and the gearbox is configured to drive the transmission device, causing the transmission device to drive the transporter on the track; two hydraulic jacks are arranged between the cargo container and the chassis frame for adjusting a height of the cargo container; the electromagnetic braking device is arranged on a bottom of the chassis frame for braking the transporter; the first displacement sensor is arranged on a bottom of an end of the cargo container, and the second displacement sensor is arranged on a bottom of an opposite end of the cargo container, for detecting a distance between each of the end and the opposite end of the cargo container and the chassis frame, facilitating the controller to adjust extension or retraction of the two hydraulic jacks, for adjusting the cargo container to a same horizontal plane; the second inclination sensor is arranged on a top of the cargo container for detecting a tilt angle of the cargo container; the first inclination sensor is configured to detect a tilt angle of the head; the first inclination sensor and the second inclination sensor are configured to transmit collected information to the controller; the controller is further configured to control the two hydraulic jacks to adjust a front height and a rear height of the cargo container, keeping the cargo container on the same horizontal plane to prevent the cargo from falling; the speed sensor is configured to detect the operating speed of the transporter and transmit collected speed information to the controller; the controller is further configured to control the motor speed regulator to adjust the rotational speed of the electric motor, for achieving feedback control of the operating speed of transporter, enabling the transporter to travel at a preset speed; the two second iron caster wheels below the cargo container and the first iron caster wheel below the head are configured to move within the sliding groove of the track.

In some embodiments, the transmission device of the present disclosure includes a transmission shaft and a gear. After the electric motor drives the gearbox, it drives the transmission shaft to rotate, which in turn drives the gear to rotate. Once the gear meshes with the rack, it drives the transporter to travel on the track.

In some embodiments, shock absorbers connect the first iron caster wheel and the second iron caster wheel to the chassis frame.

In some embodiments, the electromagnetic braking device includes two springs, a relay, an electromagnet, and an iron block; the two springs connect the iron block to a bottom of the chassis frame, and the iron block is located above the track; the relay and the electromagnet are arranged on the bottom of the chassis frame; a control terminal of the relay is connected to the controller; a normally open terminal of the relay is connected to a power supply output from the generator; a common terminal of the relay is connected to the electromagnet; the controller is further configured to control switching of the relay, for controlling operation of the electromagnet;
in a case where braking is not required, the controller turns on the relay, causing the electromagnet to be energized and generate a magnetic field, and the electromagnet attracts the iron block, lifting the iron block away from the rail;
in a case where braking is required, the controller stops the electric motor from rotating; meshing of the gear and the rack brakes the transporter; the controller turns off the relay, disconnecting power supply to the electromagnet; the iron block is pushed against the track by the spring, utilizing a friction between the iron block and the rail to achieve secondary braking.

In some embodiments, a scheme for achieving automatic leveling of the transporter is as follows:
in a case where the transporter encounters a downhill section, the tilt angle of the head that is leading changes; the first inclination sensor collects change information and transmits the change information to the controller; the controller then begins to control an output of the motor speed regulator, for controlling the rotational speed of the electric motor to prevent the transporter from overturning due to excessive speed; subsequently, the second inclination sensor transmits collected information to the controller; because when the transporter is going downhill, the front of the cargo container is caused to be lower than the rear of the cargo container; the controller controls a corresponding hydraulic jack on a bottom of the front of the cargo container to extend, raising the front; the second inclination sensor continuously collects the tilt angle of the cargo container until the cargo container reaches a horizontal level, at which point the controller stops the corresponding hydraulic jack; in a case where the second inclination sensor detects that the front of the cargo container is higher than the rear of the cargo container, the controller controls the corresponding hydraulic jack on the bottom of the front of the cargo container to retract, lowering the front height of the cargo container so that the front and the rear of the cargo container are at the same horizontal level; as the front of the cargo container rises, the first displacement sensor continuously monitors a distance between the front of the cargo container and the chassis frame; based on displacement information from the first displacement sensor, the controller controls the length-adjustable motors on both sides of the cargo container to retract, pulling the two self-stabilizers downward; in a case where the corresponding hydraulic jack on the bottom of the front of the cargo container retracts, the controller controls the length-adjustable motors to extend, moving the two self-stabilizers upward, ensuring that the two self-stabilizers always remain at a same level as the two auxiliary rails;
in a case where the transporter encounters an uphill section, the tilt angle of the head that is leading changes; the first inclination sensor collects change information and transmits the change information to the controller; the controller then begins to control an output of the motor speed regulator, for increasing the rotational speed of the electric motor, enabling the transporter to maintain a same speed while climbing uphill; subsequently, the second inclination sensor transmits collected information to the controller; because when the transporter is going uphill, the front of the cargo container is caused to be higher than the rear of the cargo container; the controller controls a corresponding hydraulic jack on a bottom of the rear of the cargo container to extend, raising the rear; the second inclination sensor continuously collects the tilt angle of the cargo container until the cargo container reaches a horizontal level, at which point the controller stops the corresponding hydraulic jack; as the front of the cargo container rises, the second displacement sensor continuously monitors a distance between the rear of the cargo container and the chassis frame; based on displacement information from the second displacement sensor, the controller controls the length-adjustable motors on both sides of the cargo container to retract, pulling the two self-stabilizers downward; in a case where the corresponding hydraulic jack on the bottom of the rear of the cargo container retracts, the controller controls the length-adjustable motors to extend, moving the two self-stabilizers upward, ensuring that the two self-stabilizers always remain at a same level as the two auxiliary rails;
in a case where the transporter is traveling on a level section, the controller does not need to adjust the two hydraulic jacks and the length-adjustable motors.

### BRIEF DESCRIPTION OF THE DRAWINGS

FIG. 1 is a schematic view of the overall structure of a level monitoring and automatic leveling system for a rail transporter according to the present disclosure.

FIG. 2 is a structural schematic view of a bracket of the level monitoring and automatic leveling system according to the present disclosure.

FIG. 3 is a structural schematic view of a track of the level monitoring and automatic leveling system according to the present disclosure.

FIG. 4 is a structural schematic view of a transporter of the level monitoring and automatic leveling system according to the present disclosure.

FIG. 5 is a structural schematic view of a transmission device of the level monitoring and automatic leveling system according to the present disclosure.

FIG. 6 is a schematic installation view of a shock absorber of the level monitoring and automatic leveling system according to the present disclosure.

FIG. 7 is a structural schematic view of an electromagnetic braking device of the level monitoring and automatic leveling system according to the present disclosure.

FIG. 8 is a structural schematic view of a self-stabilizer of the level monitoring and automatic leveling system according to the present disclosure.

FIG. 9 is a schematic diagram of the working principle of the level monitoring and automatic leveling system according to the present disclosure;

FIG. 10 is a flowchart of the automatic leveling scheme for the transporter of the level monitoring and automatic leveling system according to the present disclosure.

### REFERENCE NUMERALS

| | | | |
|---|---|---|---|
| Transporter | 1 | Auxiliary rail | 2 |
| Bracket | 3 | Support Column | 4 |
| Track | 5 | Crossbar | 6 |
| Vertical Rod | 7 | Self-stabilizer | 8 |
| Sliding Groove | 9 | Rack | 10 |
| Head | 11 | Fuel Tank | 12 |
| Generator | 13 | Controller | 14 |
| Motor Speed Regulator | 15 | Electric Motor | 16 |
| Speed Sensor | 17 | Transmission Device | 18 |
| Gearbox | 19 | First Iron Caster Wheel | 20 |
| First Inclination Sensor | 21 | Hydraulic Jack | 22 |
| Electromagnetic Braking Device | 23 | Second Iron Caster Wheel | 24 |
| Chassis Frame | 25 | Cargo Container | 26 |
| Second Inclination Sensor | 27 | First Displacement Sensor | 28 |
| Second Displacement Sensor | 29 | Transmission Shaft | 30 |
| Gear | 31 | Shock Absorber | 32 |
| Spring | 33 | Relay | 34 |
| Electromagnet | 35 | Iron Block | 36 |
| Hydraulic Damping | 37 | Third Iron Caster Wheel | 38 |
| Slider | 39 | Length-adjustable Motor | 40 |

### DETAILED DESCRIPTION

The present disclosure is described in further detail below with reference to the embodiments and accompanying drawings.

### Technical Problem

In order to solve the problems mentioned above, the objective of the present disclosure is to provide a level monitoring and automatic leveling system for a rail transporter. Auxiliary rails are added on both sides of the monorail transport track to prevent the transporter from swaying left and right. By detecting the ramp condition, the tilt angle of the transporter is adjusted to achieve a level state, thereby preventing transported goods from falling. A feedback regulation device enables the transporter to operate at a set speed. An electromagnetic braking system is used to achieve braking of the transporter. This method can prevent the transporter from swaying and overturning, prevent goods from falling, maintain a certain operating speed, allow for emergency braking in unexpected situations, and improve the safety, efficiency, and quality of the transporter. It is scalable, is expected to align with the development trend of modern intelligent manufacturing, and has good application prospects and market demand.

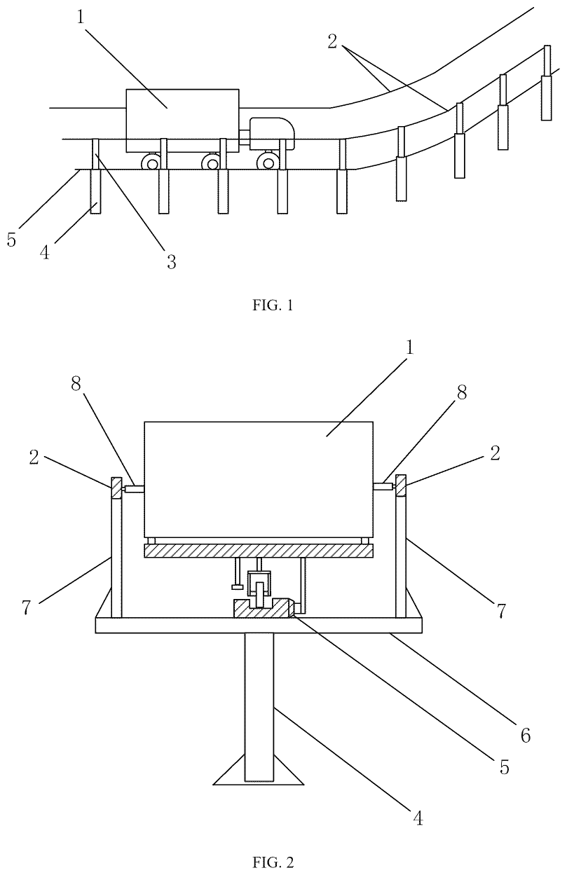

Referring to FIGS. 1 to 10, which show a level monitoring and automatic leveling system for a rail transporter according to the present disclosure, including a transporter 1, two auxiliary rails 2, brackets 3, support columns 4, and a track 5.

As shown in FIG. 1, the brackets 3 are fixed onto the support columns 4. The track 5 is arranged on the brackets 3. The brackets 3 are U-shaped brackets 3. The two auxiliary rails 2 are arranged on two ends of each bracket 3. The transporter 1 is configured to run on the track 5 and maintain the balance of the left and right ends of the transporter 1 through the two auxiliary rails 2. This method may prevent the transporter 1 from swaying side to side and overturning. During the process of transporting goods, the transporter 1 can automatically detect its own tilt angle. When the tilt angle deviates, the horizontal position of a cargo container 26 of the transporter 1 can be automatically adjusted, ensuring that the cargo container 26 of the transporter 1 remains in a horizontal state, thereby achieving the purpose of automatic leveling to prevent transported goods from falling. By detecting the speed of the transporter 1, its operating speed is adjusted, enabling the transporter 1 to run at a set speed. An electromagnetic braking device 23 is configured to achieve braking of the transporter 1, preventing cargo from falling and enabling emergency braking in unexpected situations. This may improve the safety, efficiency, and quality of the transporter 1, offer scalability, be expected to align with the development trend of modern intelligent manufacturing, and have good application prospects and market demand.

As shown in FIG. 2, each bracket 3 includes a crossbar 6 and two vertical rods 7. The crossbar 6 is arranged on a corresponding support column 4. The two vertical rods 7 are fixed on two ends of the crossbar 6. Each vertical rod 7 supports a corresponding auxiliary rail 2. Two self-stabilizers 8 are arranged, each between the transporter 1 and a corresponding auxiliary rail 2 to prevent the transport vehicle from swaying side to side. By providing the vertical rods 7 and auxiliary rails 2 on the ends of the crossbar 6, the stability of the entire bracket 3 may be effectively increased. The support columns 4 can provide support and transmit the gravity of the transporter 1 to the ground, allowing the transporter 1 to run more smoothly. In addition, the use of the self-stabilizers 8 may further improve the stability of the transport vehicle, preventing side-to-side sway.

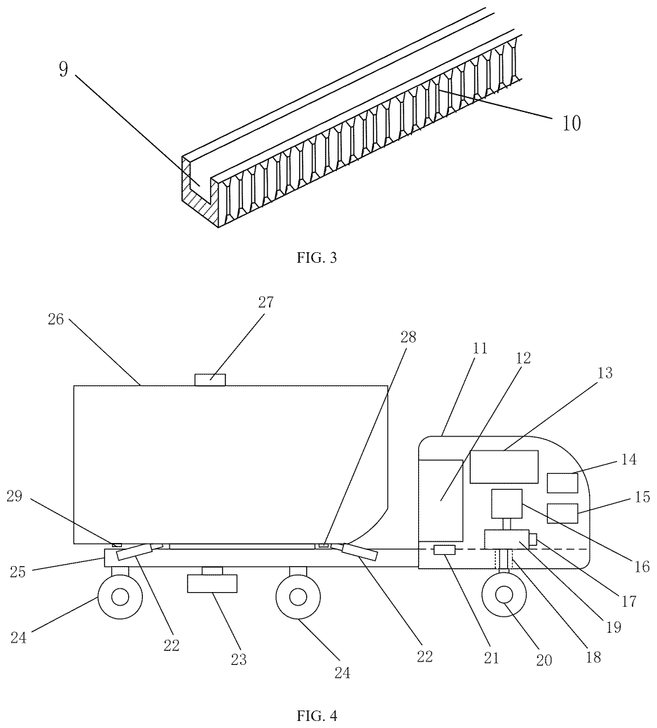

As shown in FIGS. 3 and 5, the track 5 includes a sliding groove 9 and a rack 10. The track 5 may be forged from carbon steel. A middle of the track 5 is recessed to define the sliding groove 9, and a right side of the track 5 is arranged with the rack 10. The sliding groove 9 is configured to provide guidance for the movement of the transporter 1. The rack 10 is configured to mesh with a gear 31 of the transport vehicle, providing the basis for transmission of the transporter 1 and further serving a guiding role, thereby ensuring the transport vehicle travels along the predetermined direction of the track 5 and preventing lateral deviation or misalignment. Furthermore, through the rotational drive of the gear 31, the propulsion or braking of the transport vehicle can be achieved. The rack transmission enables the vehicle to run on the track 5, control speed and acceleration/deceleration, and meet specific transport requirements.

As shown in FIG. 4, the transporter 1 includes a head 11, a fuel tank 12, a generator 13, a controller 14, a motor speed regulator 15, an electric motor 16, a speed sensor 17, a transmission device 18, a gearbox 19, a first iron caster wheel 20, a first inclination sensor 21, a hydraulic jack 22, an electromagnetic braking device 23, a second iron caster wheel 24, a chassis frame 25, a cargo container 26, a second inclination sensor 27, a first displacement sensor 28, and a second displacement sensor 29. The head 11 and the cargo container 26 are arranged on the chassis frame 25. The first iron caster wheel 20 and the second iron caster wheel 24 are arranged below the chassis frame 25, respectively. The fuel tank 12, the generator 13, the controller 14, the motor speed regulator 15, the electric motor 16, the speed sensor 17, the gearbox 19, and the first inclination sensor 21 are all arranged in the head 11. The fuel tank 12 is configured to supply gasoline to the generator 13. The generator 13 is configured to convert gasoline into electrical energy to power the electric motor 16. The controller 14 is electrically connected to the motor speed regulator 15. The motor speed regulator 15 is electrically connected to the electric motor 16. The controller 14 is configured to control the output of the motor speed regulator 15, thereby controlling the speed of the electric motor 16. A rotating shaft of the electric motor 16 is connected to the gearbox 19. An output end of the gearbox 19 is connected to the transmission device 18. The electric motor 16 is configured to drive the gearbox 19, and the gearbox 19 is configured to drive the transmission device 18, causing the transmission device 18 to drive the transporter 1 along the track 5. Two hydraulic jacks 22 are arranged between the cargo container 26 and the chassis frame 25 for adjusting the height of the cargo container. The electromagnetic braking device 23 is arranged on a bottom of the chassis frame 25 for braking the transporter 1. The first displacement sensor 28 and the second displacement sensor 29 are arranged on a bottom of the two ends of the cargo container 26, respectively, for detecting the distance between each end of the cargo container 26 and the chassis frame 25, facilitating the controller 14 to adjust the extension/retraction of the hydraulic jacks 22, thereby adjusting the cargo container 26 to the same horizontal plane. The second inclination sensor 27 is arranged on a top of the cargo container 26 for detecting the tilt angle of the cargo container 26. The first inclination sensor 21 is configured to detect the tilt angle of the head 11. The first inclination sensor 21 and the second inclination sensor 27 are configured to transmit the collected information to the controller 14. The controller 14 is configured to control the hydraulic jacks 22 to adjust the front and rear height of the cargo container 26, keeping the cargo container 26 on the same horizontal plane to prevent cargo from falling. The speed sensor 17 is configured to detect the operating speed of the transporter 1 and transmit the collected speed information to the controller 14. The controller 14 is further configured to control the motor speed regulator 15 to adjust the speed of the electric motor 16, thereby achieving feedback control of the transporter's speed, allowing the transporter 1 to travel at a preset speed. The two second iron caster wheels 24 below the cargo container 26 and the first iron caster wheel 20 below the head 11 are configured to move within the sliding groove 9 of the track 5. By collecting speed and tilt angle information of the transporter 1 and using the controller 14 to adjust the electric motor 16 and the hydraulic jacks 22, the stability of the transporter 1 during travel may be maintained. With the feedback signal from the speed sensor 17, the transporter 1 can respond and adjust promptly, thereby ensuring the cargo container 26 remains level and preventing cargo from falling.

As shown in FIG. 5, the transmission device 18 includes a transmission shaft 30 and the gear 31. After the electric motor 16 drives the gearbox 19, it drives the transmission shaft 30 to rotate, which in turn drives the gear 31 to rotate. Once the gear 31 meshes with the rack 10, it drives the transporter 1 to travel on the track 5.

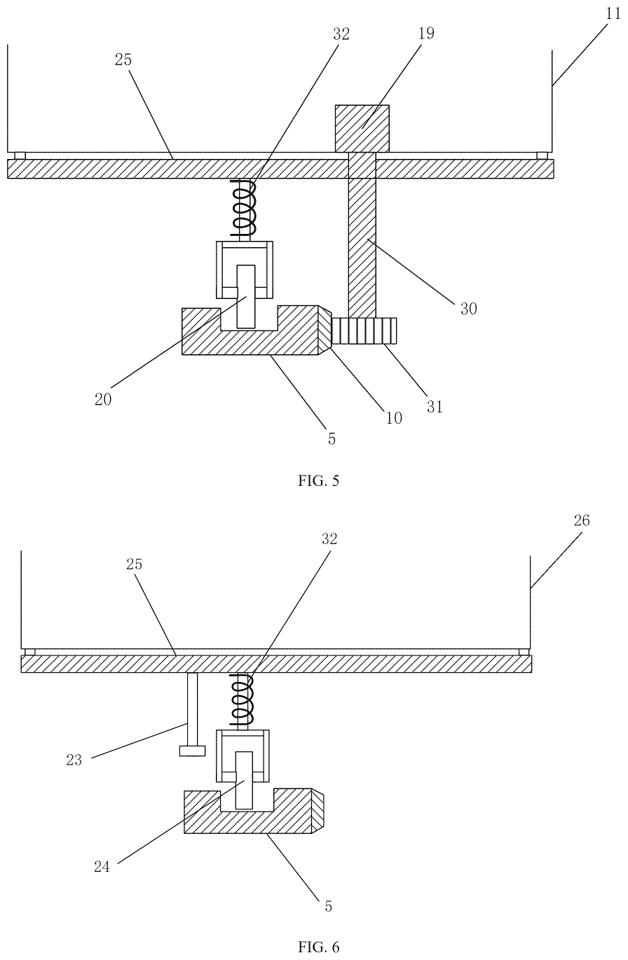

As shown in FIG. 6, a shock absorber 32 is arranged to connect each of the first iron caster wheel 20 and the second iron caster wheel 24 to the chassis frame 25. The shock absorbers 32 can absorb and reduce vibrations and impacts during the operation of the transporter 1, thereby reducing collisions of agricultural products during transport. The connection between the iron caster wheels 20, 24 and the chassis frame 25 is buffered and the transmission of vibration is reduced through the shock absorbers 32, thereby effectively lowering the vibration level of the transporter 1.

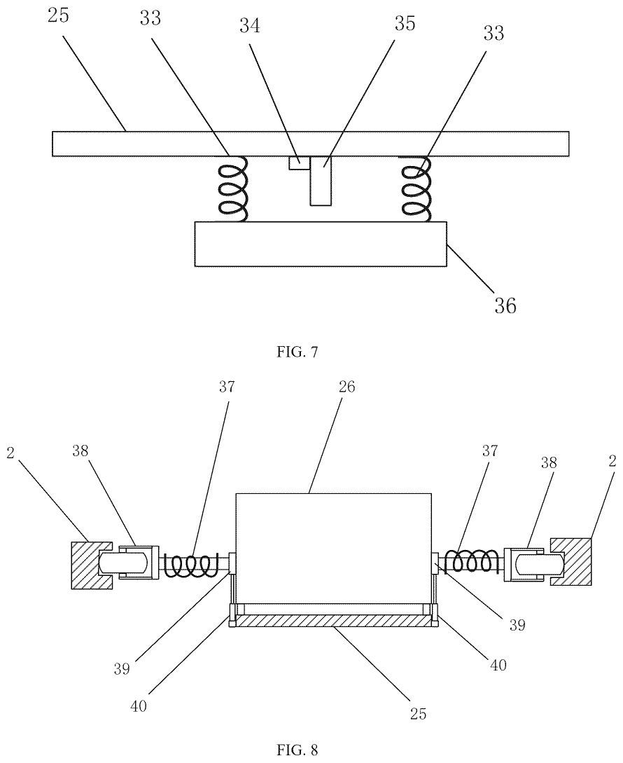

As shown in FIG. 7, the electromagnetic braking device 23 includes two springs 33, a relay 34, an electromagnet 35, and an iron block 36. The two springs 33 connect the iron block 36 to a bottom of the chassis frame 25, with the iron block 36 positioned above the track 5. The relay 34 and the electromagnet 35 are arranged on the bottom of the chassis frame 25. A control terminal of the relay 34 is connected to the controller 14. A normally open terminal of the relay 34 is connected to the power supply output from the generator 13. A common terminal of the relay 34 is connected to the electromagnet 35. The controller 14 is configured to control the switching of the relay 34, thereby controlling the operation of the electromagnet 35. When braking is not required, the controller 14 turns on the relay 34, energizing the electromagnet 35 to generate a magnetic field, which then attracts the iron block 36, lifting it away from the track 5. When braking is required, the controller 14 stops the electric motor, and the meshing of the gear 31 and the rack 10 brakes the transporter 1. Simultaneously, the controller 14 turns off the relay 34, disconnecting the power to the electromagnet 35. The spring 33 then pushes the iron block 36 against the track 5, utilizing the friction between the iron block 36 and the track 5 to achieve secondary braking. When braking is not required, the energized electromagnet 35 generates a magnetic field to lift the iron block 36 away from the track 5, reducing energy loss due to friction. Secondary braking is activated only when needed by disconnecting the power to the electromagnet 35, providing appropriate braking force. These two braking methods may improve the braking effect of the transporter 1 on steep slopes, reduce the braking distance, and increase overall safety.

As shown in FIG. 8, each self-stabilizer 8 includes a hydraulic damper 37, a third iron caster wheel 38, a slider 39, and a length-adjustable motor 40. The two self-stabilizers 8 are arranged on the left and right sides of the cargo container 26, respectively. A bottom of the length-adjustable motor 40 is fixed to the chassis frame 25. A length-adjustable rod of the length-adjustable motor 40 is connected to the slider 39. The third iron caster wheel 38 is connected to the slider 39 via the hydraulic damper 37. The hydraulic damper 37 is configured to push the third iron caster wheel 38 into the sliding groove 9 of a corresponding auxiliary rail 2. When the cargo container 26 tilts left or right due to uneven force, the hydraulic damper 37 pushes it back to a balanced state. When the transport vehicle is moving, the third iron caster wheel 38 moves within the sliding groove 9 of the auxiliary rail 2. When the front or rear of the cargo container 26 is lifted by the hydraulic jack 22, the controller 14 controls the length-adjustable motor 40 to pull the slider 39 downward, keeping the third iron caster wheel 38 level with the auxiliary rail 2, preventing the self-stabilizer 8 from being overstressed and broken due to the tilt of the cargo container 26. The combination of the hydraulic damper 37, the third iron caster wheel 38, the slider 39, and the length-adjustable motor 40 may achieve automatic balancing and stabilization of the cargo container 26. When the cargo container 26 is subjected to uneven forces, the self-stabilizer 8 can adjust promptly, returning the cargo container 26 to a balanced state to maintain stable transport.

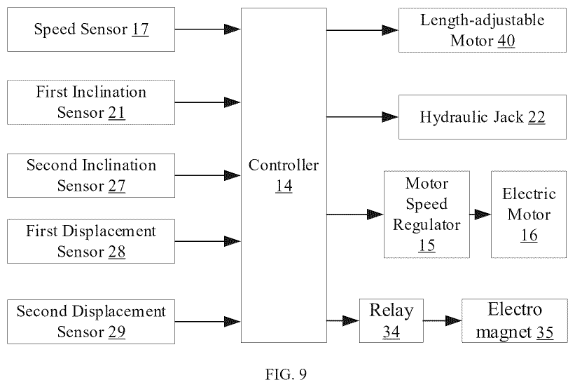

As shown in FIG. 9, the automatic leveling scheme of the present disclosure is as follows: When the transporter 1 encounters a downhill section, the tilt angle of the leading head 11 changes. The first inclination sensor 21 collects this change and transmits it to the controller 14. The controller 14 then controls the output of the motor speed regulator 15, thereby controlling the speed of the electric motor 16 to prevent the transporter 1 from speeding and overturning. Subsequently, the second inclination sensor 27 transmits the collected information to the controller 14. When going downhill, the front of the cargo container 26 becomes lower than the rear. The controller 14 then controls the hydraulic jack 22 at the bottom front of the cargo container 26 to extend, raising the front. The second inclination sensor 27 continuously monitors the tilt angle of the cargo container 26 until it becomes level, at which point the controller 14 stops the hydraulic jack 22. When the second inclination sensor 27 detects that the front of the cargo container 26 is higher than the rear, the controller 14 controls the hydraulic jack 22 at the bottom front to retract, lowering the front height to level the container. As the front of the cargo container 26 rises, the first displacement sensor 28 continuously monitors the distance between the front of the cargo container 26 and the chassis frame 25. Based on this information, the controller 14 controls the length-adjustable motors 40 on both sides of the cargo container 26 to retract, pulling the self-stabilizers 8 downward. When the front hydraulic jack 22 retracts, the controller 14 controls the length-adjustable motors 40 to extend, raising the self-stabilizers 8 to keep them level with the auxiliary rails 2. When the transporter 1 encounters an uphill section, the tilt angle of the leading head 11 changes. The first inclination sensor 21 collects this change and transmits it to the controller 14. The controller 14 then controls the output of the motor speed regulator 15 to increase the speed of the electric motor 16, maintaining a consistent climbing speed. Subsequently, the second inclination sensor 27 transmits the collected information to the controller 14. When going uphill, the front of the cargo container 26 becomes higher than the rear. The controller 14 then controls the hydraulic jack 22 at the bottom rear of the cargo container 26 to extend, raising the rear. The second inclination sensor 27 continuously monitors the tilt angle until the cargo container 26 is level, then the controller 14 stops the hydraulic jack 22. As the rear of the cargo container 26 rises, the second displacement sensor 29 continuously monitors the distance between the rear of the cargo container 26 and the chassis frame 25. Based on this information, the controller 14 controls the length-adjustable motors 40 on both sides to retract, pulling the self-stabilizers 8 downward. When the rear hydraulic jack 22 retracts, the controller 14 controls the length-adjustable motors 40 to extend, raising the self-stabilizers 8 to keep them level with the auxiliary rails 2. When the transporter 1 is traveling on a level section, the controller 14 does not need to adjust the hydraulic jacks 22 or the length-adjustable motors 40. This automatic leveling scheme uses tilt information from the first and second inclination sensors 21, 27 to adjust the transport vehicle's speed and the levelness of the cargo container 26, maintaining balance, which may help prevent overturning or imbalance on slopes. The scheme further maintains climbing speed on uphill sections, avoiding slow speeds or stalling, thereby improving transport efficiency. In addition, automatic leveling may reduce reliance on operators and enhances the automation level of the transporter 1.

Working Principle and Process of the present disclosure.

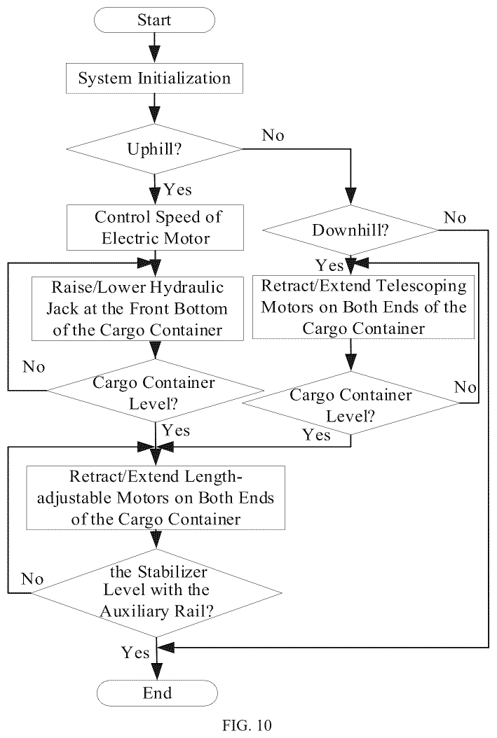

As shown in FIG. 10, the speed sensor 17 detects the operating speed of the transporter 1 and transmits the collected speed information to the controller 14. The controller 14 then controls the motor speed regulator 15 to adjust the rotational speed of the electric motor 16, thereby achieving feedback control of the speed of the transporter 1 and enabling the transporter 1 to travel at a preset speed. The controller 14 controls the switching of the relay 34, thereby controlling the operation of the electromagnet 35. When braking is not required, the controller 14 turns on the relay 34, causing the electromagnet 35 to be energized and generate a magnetic field, which then attracts the iron block 36, lifting it away from the track 5. When braking is required, the controller 14 stops the electric motor from rotating. The meshing of the gear 31 and the rack 10 brakes the transporter 1. At this time, the controller 14 turns off the relay 34, disconnecting the power supply to the electromagnet 35. The iron block 36 is pushed against the track 5 by the spring 33, utilizing the friction between the iron block 36 and the track 5 to achieve secondary braking. When the transporter 1 encounters a downhill section, the tilt angle of the leading head 11 changes. The first inclination sensor 21 collects this change information and transmits it to the controller 14. The controller 14 then begins to control the output of the motor speed regulator 15, thereby controlling the rotational speed of the electric motor 16 to prevent the transporter 1 from overturning due to excessive speed. Subsequently, the second inclination sensor 27 transmits the collected information to the controller 14. Because when the transporter 1 is going downhill, it causes the front of the cargo container 26 to be lower than the rear, the controller 14 controls the hydraulic jack 22 at the bottom of the front of the cargo container 26 to extend, raising the front. The second inclination sensor 27 continuously collects the tilt angle of the cargo container 26 until the cargo container 26 reaches a horizontal level, at which point the controller 14 stops the hydraulic jack 22. When the second inclination sensor 27 detects that the front of the cargo container 26 is higher than the rear, the controller 14 controls the hydraulic jack 22 at the bottom of the front of the cargo container 26 to retract, lowering the front height of the cargo container 26 so that the front and rear ends of the cargo container 26 are at the same horizontal level. As the front of the cargo container 26 rises, the first displacement sensor 28 continuously monitors the distance between the front of the cargo container 26 and the chassis frame 25. Based on the displacement information from the first displacement sensor 28, the controller 14 controls the length-adjustable motors 40 on both sides of the cargo container 26 to retract, pulling the self-stabilizers 8 downward. When the hydraulic jack 22 at the bottom of the front of the cargo container 26 retracts, the controller 14 controls the length-adjustable motors 40 to extend, moving the self-stabilizers 8 upward, ensuring that the self-stabilizers 8 always remain at the same level as the auxiliary rails 2. When the transporter 1 encounters an uphill section, the tilt angle of the leading head 11 changes. The first inclination sensor 21 collects this change information and transmits it to the controller 14. The controller 14 then begins to control the output of the motor speed regulator 15, thereby increasing the rotational speed of the electric motor 16, allowing the transport vehicle to maintain the same speed while climbing uphill. Subsequently, the second inclination sensor 27 transmits the collected information to the controller 14. Because when the transporter 1 is going uphill, it causes the front of the cargo container 26 to be higher than the rear, the controller 14 controls the hydraulic jack 22 at the bottom of the rear of the cargo container 26 to extend, raising the rear. The second inclination sensor 27 continuously collects the tilt angle of the cargo container 26 until the cargo container 26 reaches a horizontal level, at which point the controller 14 stops the hydraulic jack 22. As the front of the cargo container 26 rises, the second displacement sensor 29 continuously monitors the distance between the rear of the cargo container 26 and the chassis frame 25. Based on the displacement information from the second displacement sensor 29, the controller 14 controls the length-adjustable motors 40 on both sides of the cargo container 26 to retract, pulling the self-stabilizers 8 downward. When the hydraulic jack 22 at the bottom of the rear of the cargo container 26 retracts, the controller 14 controls the length-adjustable motors 40 to extend, moving the self-stabilizers 8 upward, ensuring that the self-stabilizers 8 always remain at the same level as the auxiliary rails 2. When the transporter 1 is traveling on a level section, the controller 14 does not need to adjust the hydraulic jacks 22 and the length-adjustable motors 40.

### Beneficial Effects

Because the present disclosure adopts the structure where the second inclination sensor detects the tilt angle of the cargo container and then adjusts the front and rear height of the cargo container, the following beneficial effects can be obtained:
1. Adding auxiliary rails on both sides of the monorail transporter in the present disclosure may prevent the transport vehicle from swaying left and right during operation, avoiding the risk of goods falling. Furthermore, by adjusting the tilt angle of the cargo container, the transport vehicle can be maintained in a level state, improving transport safety.
2. The dual braking system used in the present disclosure may improve the braking effect of the transporter on steep slopes, reduce the braking distance, increase overall safety, ensure the safety of the transport vehicle, and prevent accidents.

1. A level monitoring and automatic leveling system for a rail transporter, comprising: a transporter, two auxiliary rails, brackets, support columns, and a track;
wherein the brackets are fixed on the support columns, the track is arranged on the brackets; each of the brackets is a U-shaped bracket; the two auxiliary rails are arranged on both ends of each bracket; the transporter is configured to run on the track, and a balance of left and right ends of the transporter is configured to be maintained through the two auxiliary rails;
during a process of transporting cargo, the transporter is configured to automatically detect a tilt angle of the transporter; in a case where the tilt angle deviates, the transporter is configured to automatically adjust a horizontal position of a cargo container of the transporter, keeping the cargo container in a horizontal state to achieve automatic leveling; an operating speed of the transporter is configured to be adjusted by detecting the operating speed, for enabling the transporter to run at a set speed; an electromagnetic braking device is arranged to achieve braking of the transporter, preventing the cargo from falling and enabling emergency braking in unexpected situations;
wherein each bracket comprises a crossbar and two vertical rods; the track comprises a sliding groove and a rack; the crossbar is arranged on a corresponding support column; the two vertical rods are fixed on both ends of the crossbar; each vertical rod is configured to support a corresponding auxiliary rail; two self-stabilizers are arranged, each between the transporter and a corresponding auxiliary rail to prevent the transporter from swaying left and right; a middle of the track is recessed to define the sliding groove, and a right side of the track is arranged with the rack; the sliding groove is configured to provide guidance for movement of the transporter; the rack is configured to mesh with a gear of the transporter, providing a transmission foundation for the transporter and further serving a guiding role;
wherein each self-stabilizer comprises a hydraulic damper, a third iron caster wheel, a slider, and a length-adjustable motor; the two self-stabilizers are arranged on left and right sides of the cargo container respectively; a bottom of the length-adjustable motor is fixed to the chassis frame; a length-adjustable rod of the length-adjustable motor is connected to the slider; the third iron caster wheel is connected to the slider via the hydraulic damper; the hydraulic damper is configured to push the third iron caster wheel into the sliding groove of a corresponding auxiliary rail;
in a case where the cargo container shifts left or right due to uneven force, the hydraulic damper pushes the cargo container back to a balanced state;
in a case where the transporter is moving, the third iron caster wheel moves within the sliding groove of the corresponding auxiliary rail;
in a case where a front or a rear of the cargo container is lifted by the two hydraulic jacks, the controller controls the length-adjustable motor to pull the slider downward, keeping the third iron caster wheel at a same level as the corresponding auxiliary rail, preventing the self-stabilizer from being overstressed and broken due to tilt of the cargo container.

2. The level monitoring and automatic leveling system according to claim 1, wherein the transporter comprises a head, a fuel tank, a generator, a controller, a motor speed regulator, an electric motor, a speed sensor, a transmission device, a gearbox, a first iron caster wheel, a first inclination sensor, a hydraulic jack, an electromagnetic braking device, two second iron caster wheels, a chassis frame, a cargo container, a second inclination sensor, a first displacement sensor, and a second displacement sensor; the head and the cargo container are arranged on the chassis frame; the first iron caster wheel and the two second iron caster wheels are arranged below the chassis frame respectively; the fuel tank, the generator, the controller, the motor speed regulator, the electric motor, speed sensor, the gearbox, and the first inclination sensor are all arranged in the head; the fuel tank is configured to supply gasoline to the generator; the generator is configured to convert the gasoline into electrical energy to power the electric motor; the controller is electrically connected to the motor speed regulator; the motor speed regulator is electrically connected to the electric motor; the controller is configured to control an output of the motor speed regulator, for controlling a rotational speed of the electric motor; a rotating shaft of the electric motor is connected to the gearbox; an output end of the gearbox is connected to the transmission device; the electric motor is configured to drive the gearbox, and the gearbox is configured to drive the transmission device, causing the transmission device to drive the transporter on the track; two hydraulic jacks are arranged between the cargo container and the chassis frame for adjusting a height of the cargo container; the electromagnetic braking device is arranged on a bottom of the chassis frame for braking the transporter; the first displacement sensor is arranged on a bottom of an end of the cargo container, and the second displacement sensor is arranged on a bottom of an opposite end of the cargo container, for detecting a distance between each of the end and the opposite end of the cargo container and the chassis frame, facilitating the controller to adjust extension or retraction of the two hydraulic jacks, for adjusting the cargo container to a same horizontal plane; the second inclination sensor is arranged on a top of the cargo container for detecting a tilt angle of the cargo container; the first inclination sensor is configured to detect a tilt angle of the head; the first inclination sensor and the second inclination sensor are configured to transmit collected information to the controller; the controller is further configured to control the two hydraulic jacks to adjust a front height and a rear height of the cargo container, keeping the cargo container on the same horizontal plane to prevent the cargo from falling; the speed sensor is configured to detect the operating speed of the transporter and transmit collected speed information to the controller; the controller is further configured to control the motor speed regulator to adjust the rotational speed of the electric motor, for achieving feedback control of the operating speed of transporter, enabling the transporter to travel at a preset speed; the two second iron caster wheels below the cargo container and the first iron caster wheel below the head are configured to move within the sliding groove of the track.

3. The level monitoring and automatic leveling system according to claim 2, wherein the electromagnetic braking device comprises two springs, a relay, an electromagnet, and an iron block; the two springs connect the iron block to a bottom of the chassis frame, and the iron block is located above the track; the relay and the electromagnet are arranged on the bottom of the chassis frame; a control terminal of the relay is connected to the controller; a normally open terminal of the relay is connected to a power supply output from the generator; a common terminal of the relay is connected to the electromagnet; the controller is further configured to control switching of the relay, for controlling operation of the electromagnet;
in a case where braking is not required, the controller turns on the relay, causing the electromagnet to be energized and generate a magnetic field, and the electromagnet attracts the iron block, lifting the iron block away from the rail;
in a case where braking is required, the controller stops the electric motor from rotating; meshing of the gear and the rack brakes the transporter; the controller turns off the relay, disconnecting power supply to the electromagnet; the iron block is pushed against the track by the spring, utilizing a friction between the iron block and the rail to achieve secondary braking.

4. The level monitoring and automatic leveling system according to claim 2, wherein a scheme for achieving automatic leveling of the transporter is as follows:
in a case where the transporter encounters a downhill section, the tilt angle of the head that is leading changes; the first inclination sensor collects change information and transmits the change information to the controller; the controller then begins to control an output of the motor speed regulator, for controlling the rotational speed of the electric motor to prevent the transporter from overturning due to excessive speed; subsequently, the second inclination sensor transmits collected information to the controller; because when the transporter is going downhill, the front of the cargo container is caused to be lower than the rear of the cargo container; the controller controls a corresponding hydraulic jack on a bottom of the front of the cargo container to extend, raising the front; the second inclination sensor continuously collects the tilt angle of the cargo container until the cargo container reaches a horizontal level, at which point the controller stops the corresponding hydraulic jack; in a case where the second inclination sensor detects that the front of the cargo container is higher than the rear of the cargo container, the controller controls the corresponding hydraulic jack on the bottom of the front of the cargo container to retract, lowering the front height of the cargo container so that the front and the rear of the cargo container are at the same horizontal level; as the front of the cargo container rises, the first displacement sensor continuously monitors a distance between the front of the cargo container and the chassis frame; based on displacement information from the first displacement sensor, the controller controls the length-adjustable motors on both sides of the cargo container to retract, pulling the two self-stabilizers downward; in a case where the corresponding hydraulic jack on the bottom of the front of the cargo container retracts, the controller controls the length-adjustable motors to extend, moving the two self-stabilizers upward, ensuring that the two self-stabilizers always remain at a same level as the two auxiliary rails;
in a case where the transporter encounters an uphill section, the tilt angle of the head that is leading changes; the first inclination sensor collects change information and transmits the change information to the controller; the controller then begins to control an output of the motor speed regulator, for increasing the rotational speed of the electric motor, enabling the transporter to maintain a same speed while climbing uphill; subsequently, the second inclination sensor transmits collected information to the controller; because when the transporter is going uphill, the front of the cargo container is caused to be higher than the rear of the cargo container; the controller controls a corresponding hydraulic jack on a bottom of the rear of the cargo container to extend, raising the rear; the second inclination sensor continuously collects the tilt angle of the cargo container until the cargo container reaches a horizontal level, at which point the controller stops the corresponding hydraulic jack; as the front of the cargo container rises, the second displacement sensor continuously monitors a distance between the rear of the cargo container and the chassis frame; based on displacement information from the second displacement sensor, the controller controls the length-adjustable motors on both sides of the cargo container to retract, pulling the two self-stabilizers downward; in a case where the corresponding hydraulic jack on the bottom of the rear of the cargo container retracts, the controller controls the length-adjustable motors to extend, moving the two self-stabilizers upward, ensuring that the two self-stabilizers always remain at a same level as the two auxiliary rails;
in a case where the transporter is traveling on a level section, the controller does not need to adjust the two hydraulic jacks and the length-adjustable motors.
